(19) United States
(12) Patent Application Publication
(10) Pub. No.: US 2013/0240501 A1
(43) Pub. Date: Sep. 19, 2013

(54) SELF REGULATED FOOD WARMER

(71) Applicant: Roberto Leon Gonzalez, Miami, FL (US)

(72) Inventor: Roberto Leon Gonzalez, Miami, FL (US)

(21) Appl. No.: 13/418,445

(22) Filed: Mar. 13, 2012

(51) Int. Cl. H05B 3/68

(52) U.S. Cl. 219/447.1

(57) ABSTRACT

A self-regulated food warmer that blows hot air onto food whenever a weight is placed on its food shelf. The self-regulated food warmer conserves energy by powering down when not in use, utilizes hot air to keep food warm, eliminates the costs of replacing heat lamps, and eliminates dangerously hot plates.

### BACKGROUND

The present invention is directed to a self-regulated food warmer that conserves energy and is ecologically sustainable by powering down when not in use. The food warmer also utilizes hot air to warm the food.

The inventor of the present invention conceived his invention while working in the restaurant industry. He noticed that during slow dining periods, there were no plates of food underneath the food warmer, yet the food warmer was still powered on. This unnecessary utilization of the food warmer was wasting energy and not ecologically sustainable. Restaurant managers were constantly complaining to the inventor about their large energy bills. The inventor turned the food warmer off whenever he saw no food plates present, but his busy job duties prevented him from being consistent with this. And further, when the food warmer needed to be turned on again, it took too long to heat up to be effective. The cooks and waiters were not pleased with this solution.

He also realized that most food warmers utilized heat lamps or surface warmers to warm food. The restaurant industry was always complaining about the high cost of replacing heat lamps, and servers were always burning their hands on hot plates due to the plate's long period of contact with the surface warmers.

The inventor noticed that hot air from the kitchen exhaust provided a warm atmosphere, and food retained its preferred temperature when place near the kitchen exhaust fans. He therefore began leaving plates of food near the exhaust fans in the kitchen to keep them warm. However, this caused confusion for the servers and increased the delivery time to the customer's table.

The inventor noticed that most plates were relatively heavy when food was piled on to them. He researched techniques to switch an exhaust fan off and on based on weight. Through trial and error, he learned that compressed springs could activate an electrical switch, which could then power on an air blower.

The above realizations caused him first to create a pressure sensitive food shelf that did not power on unless a small weight such as a plate of food was placed on top of it. The weight activated an electrical switch that powered on a blower. He then connected the blower to a tube that was supported above the food shelf. The inventor realized that cutting holes in the bottom of the tube allowed the air to disperse onto the plates of food.

After using the self-regulating food warmer for some time, he noticed that the air was not hot enough to warm the food properly. He recalled that ceramic and porcelain plates of food retained copious amounts of heat from the surface warmers they rested on, often burning the server's hand. This realization caused him to position a. ceramic heating element alongside the blower and operatively connect it an electrical switch. Since ceramics are good insulators and have high heat retentions, an electrical current from the activated electrical switch would quickly and efficiently heat the ceramic, which in turn would heat the air being forced through the blower. The hot air would then disperse through the holes in the tube onto the food.

Food warmers have been used for keeping food warm in the past, yet none with the present characteristics of the present invention, See U.S. Pat. Nos.: 4,733,054; 4,822,981; 4,246,884; and 6,297,481.

For the foregoing reasons, there is a need for a self-regulated food warmer that will conserve energy, that will be ecologically sustainable, that will eliminate the costs of replacing heat lamps, and that will eliminate the dangers of hot plates.

### SUMMARY

The present invention is directed to a self-regulated food warmer that will conserve energy and provide ecological sustainability by powering down when not in use, that will utilize hot air to keep food warm, that will eliminate costs for replacing heat lamps, and that will eliminate dangerously hot plates.

The food warmer is comprised of a food shelf. The food shelf rests on a weight sensitive regulator. A support structure mounts on the food shelf. The support structure supports an air flow tube and a blower. The blower attaches to the support structure and one end of the air flow tube. The air flow tube defines at least one aperture that directs the flow of air towards the food shelf.

The present invention is a food warmer that powers on whenever a weight, such as a plate of food, is placed on its food shelf. The food shelf rests on a weight sensitive regulator that powers on to activate a blower, which forces hot air onto the food. This hot air is created when the blower forces air through a ceramic heating element. After flowing through the ceramic heating element, the air continues to flow through an air flow tube supported over the food shelf. Apertures located on the underside of the air flow tube then direct the flow of hot air onto the underlying food shelf. The self-regulated food warmer is used by restaurants, bars, and caterers that need to reduce energy costs, eliminate dangerous hot plates, and use hot air rather than heat lamps to keep food warm.

An object of the present invention is to reduce energy costs by powering down when no food plates are present on the food shelf.

Yet another object of the present invention is to reduce energy costs by using a blower rather than a heat lamp to warm food.

Another object of the present invention is to eliminate dangerously hot plates by using hot air blowing down onto the food rather than heat lamps or surface heaters.

A further object of the present invention is to eliminate the cost of replacing heat lamps.

### DRAWINGS

These and other features, aspects, and advantages of the present invention will become better understood with regard to the following description, appended claims, and drawings where:

FIG. 1 is a side view of the present invention;

FIG. 2 is a side view of the blower;

FIG. 3 is a top view of the under surface of the food shelf; and

FIG. 4 is a top view of the weight sensitive regulator.

### DESCRIPTION

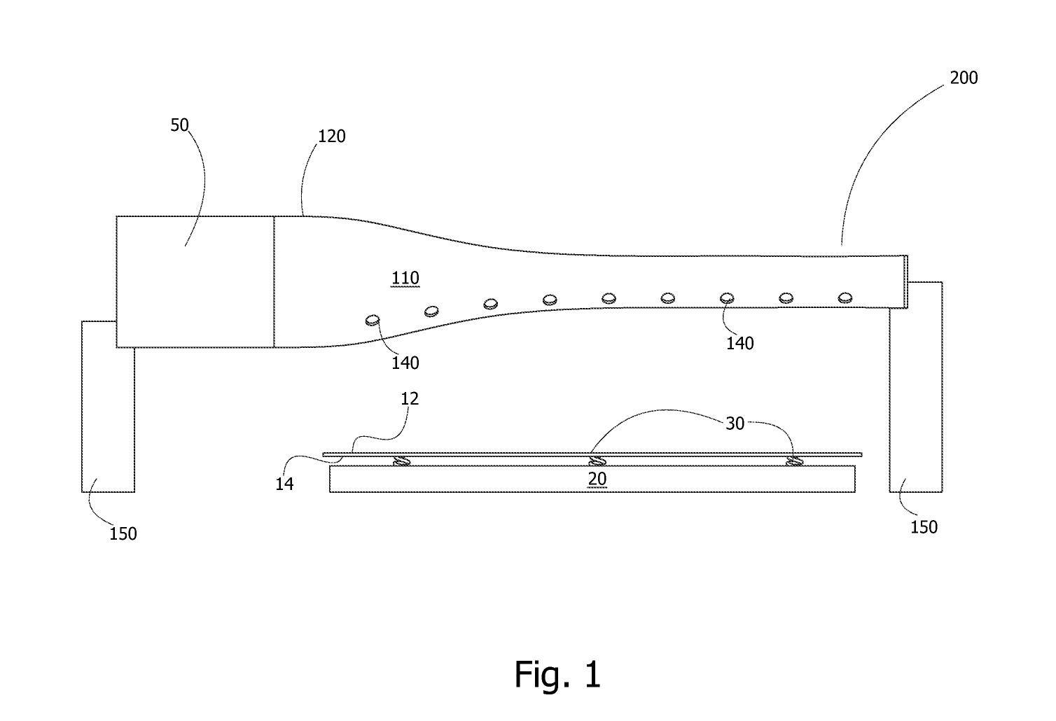

One embodiment of the self-regulated food warmer is seen in FIGS. 1-4. The self-regulated food warmer 200 activates whenever any weight, such as a plate of food, is placed on its surface and utilizes hot air to warm the plate of food.

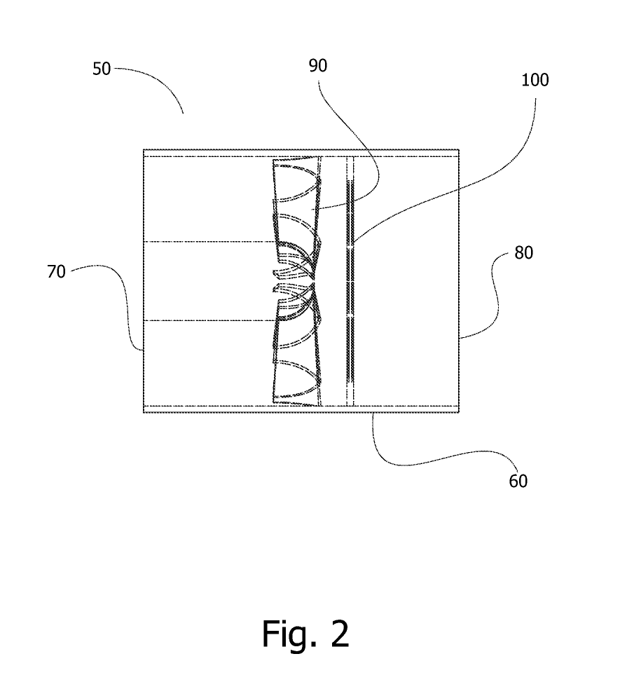

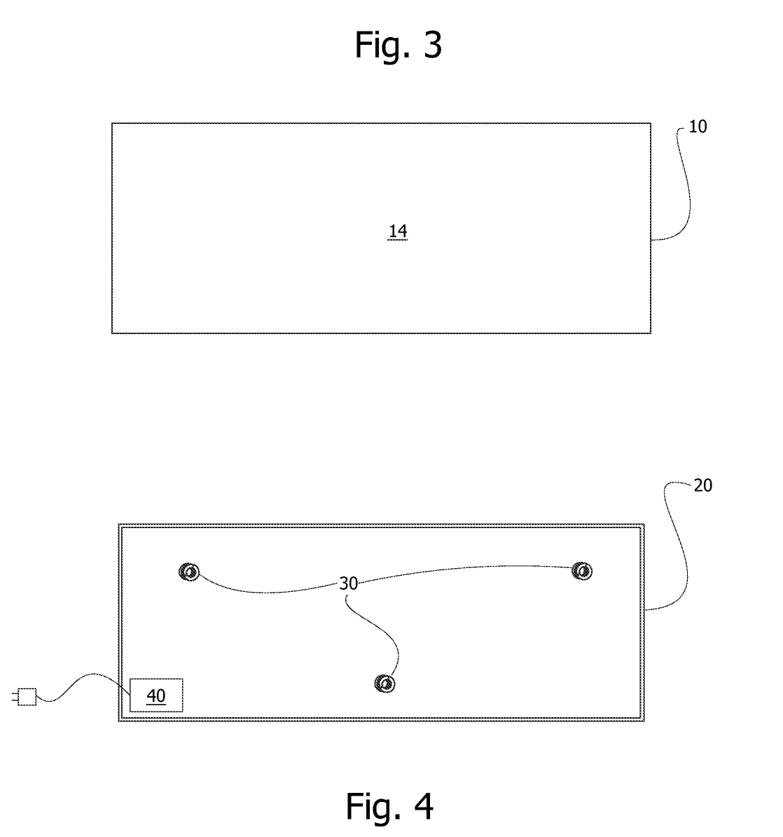

The self-regulated food warmer 200 comprises of a food shelf 10 for receiving a plurality of food servings, As seen in FIG. 3, the food shelf 10 having a flat upper surface 12 and a flat under surface 14. As seen is FIG. 1, the self-regulated food warmer 200 further comprises of a weight sensitive regulator 20 for attaching to and supporting the undersurface 14 of the food shelf 10. The weight sensitive regulator 20 comprises of a plurality of pressure sensitive springs 30. The pressure sensitive springs 30 having a spring compression constant to activate an electrical switch 40. The electrical switch 40 attaches to a power source (not shown in the figures). The self-regulated food warmer 200 also comprises of at least one blower 50 for forcing hot air onto the flat upper surface 12 of the food shelf 10. As seen in FIG. 2, the blower 50 comprises of a housing 60 having an air inlet 70 and an air outlet 80, a fan 90 arranged in the housing 60 and operatively connected to the electrical switch 40 to cause air to flow from the air inlet 70 to the air outlet 80. The blower 50 further comprises of a ceramic heating element 100 arranged between the air inlet 70 and air outlet 80 and that is operatively connected to the electrical switch 40, When the fan 90 and the ceramic heating element 100 are powered on they radiate a warm current of air to the flat upper surface 12 of the food shelf 10 via an airflow tube 110 that is connected to the air outlet 80 of the blower 50. The air flow tube 110 has two ends, a first end 120 attached to the blower's 50 air outlet 80 and a closed second end 130. The air flow tube 110 also defines a plurality of apertures 140 spaced along the longitudinal axis of the air flow tube 110, whereby the hot air forced from the blower 50 air outlet 80 disperses through the apertures 140. The self-regulated food warmer 200 further comprises of at least one support structure 150 for supporting the blower 50 and the closed second end 130 of the air flow tube 110. The support structure 150 supports the air flow tube 110 so that the apertures 140 are directed towards the food shelf 10.

In an embodiment of the present invention the self-regulated food warmer 200 is made of stainless steel.

In a further embodiment of the present invention, the ceramic heating element 100 is made of a hypo-allergenic ceramic material. The material will not oxidize and cause toxic elements to be blown onto the food.

In a further embodiment of the present invention, the ceramic heating element 100 is made of made of porcelain.

In yet another embodiment of the present invention, the power source is a portable battery.

An advantage of the present invention is that it provides energy conservation and ecological sustainability by powering off when no food plates are present.

Another advantage of the present invention is that it eliminates the cost of replacing heat lamps.

Yet another advantage of the present invention is that it eliminates the danger of hot plates.

A further advantage of the present invention is that it utilizes a blower 50 that uses less energy than a heat lamp or surface warmer.

Although the present invention has been described in considerable detail in reference to preferred versions, other versions are possible. Therefore, the spirit and scope of the appended claims should not be limited to the description of the preferred versions contained herein.

What is claimed is:

1. A self-regulating food warmer, comprising:
a food shelf for receiving a plurality of food servings, the food shelf having a flat upper surface and a flat under surface;
a weight sensitive regulator for attaching to and supporting the wider surface of the food shelf, the weight sensitive regulator comprising a plurality of pressure sensitive springs, the pressure sensitive springs having a spring compression constant to activate an electrical switch, the electrical switch attached to a power source, whereby a predetermined weight placed on the food shelf will compress the pressure sensitive springs and power on the electrical switch;
at least one blower for forcing hot air onto at least one food servings, the blower comprising a housing having an air inlet and an air outlet, a fan arranged in the housing and operatively connected to the electrical switch to cause air to flow from the air inlet to the air outlet, a ceramic heating element arranged between the air inlet and air outlet and operatively connected to the electrical switch;
at least one air flow tube for funneling hot air over the food shelf, the tube having two ends, a first end attached to the blower air outlet and a second closed end, a plurality of apertures spaced along the longitudinal axis of the air flow tube, whereby the hot air forced from the blower air outlet disperses through the apertures; and
at least one support structure for supporting the air flow tube, each support structure supports the air flow tube so that the apertures are directed towards the food shelf.

2. The self-regulated food warmer of claim 1, wherein the self-regulated food warmer is stainless steel.

3. The self-regulated food warmer of claim 2, wherein the electrical switch attaches to a portable Battery.

4. The self-regulated food warmer of claim 2, wherein the ceramic heating element is made of a hypo-allergenic ceramic material.

5. The self-regulated food warmer of claim 2, wherein the ceramic heating element is made of porcelain.
